(19) United States
(12) Patent Application Publication
(10) Pub. No.: US 2013/0157569 A1
(43) Pub. Date: Jun. 20, 2013

(54) Systems and Methods of Distributed Tag Tracking

(71) Applicants: Karl Helmer Torvmark, Dal (NO); Svein Vetti, Sandvika (NO); Per Torstein Røine, Oslo (NO)

(72) Inventors: Karl Helmer Torvmark, Dal (NO); Svein Vetti, Sandvika (NO); Per Torstein Røine, Oslo (NO)

(73) Assignee: TEXAS INSTRUMENTS NORWAY, Oslo (NO)

(21) Appl. No.: 13/329,562

(22) Filed: Dec. 19, 2011

(51) Int. Cl. H04W 80/00

(52) U.S. Cl. 455/41.2

(57) ABSTRACT

RF tags may be used to acquire data. If the tag is attached to a particular article, information regarding that article may be acquired. In an example embodiment, items are fitted with RF tags. A mobile phone or other wireless device can track when the tags are in RF range. When a user wants to know data regarding the article, he may consult the information on the phone. The phones running the system may report any compatible tags that are found, even ones that have no ownership connection to a central server where the data is compiled. “Foreign” tag information is submitted to the server and can be turned over to the owner of the tags. In this implementation, the reach of the system may be increased compared to the previous, local implementation. In an example embodiment, information may be anonymized in the server to deal with privacy concerns.

### TECHNICAL FIELD

The present disclosure is generally related to electronics and, more particularly, is related to radio frequency tracking.

### BACKGROUND

Radio Frequency identification (RFID) technology has been around since 1970; but until recently, it has been too expensive to use on a large scale. Originally, RFID tags were used to track large items, like cows, railroad cars and airline luggage that were shipped over long distances. These original tags, called inductively coupled RFID tags, were complex systems of metal coils, antennae and glass.

Inductively coupled RFID tags were powered by a magnetic field generated by the RFID reader. Electrical current has an electrical component and a magnetic component—it is electromagnetic. Because of this, you can create a magnetic field with electricity, and you can create electrical current with a magnetic field. The name “inductively coupled” comes from this process—the magnetic field inducts a current in the wire. Capacitively coupled tags were created next in an attempt to lower the technology's cost. These were meant to be disposable tags that could be applied to less expensive merchandise and made as universal as bar codes. Capacitively coupled tags used conductive carbon ink instead of metal coils to transmit data. The ink was printed on paper labels and scanned by readers. Motorola's BiStatix RFID tags were the frontrunners in this technology. They used a silicon chip that was only 3 millimeters wide and stored 96 bits of information. This technology didn't catch on with retailers, and BiStatix was shut down in 2001.

Newer innovations in the RFID industry include active, semi-active and passive RFID tags. These tags can store up to 2 kilobytes of data and are composed of a microchip, antenna and, in the case of active and semi-passive tags, a battery. The tag's components are enclosed within plastic, silicon or sometimes glass.

At a basic level, each tag works in the same way: Data stored within an RFID tag's microchip waits to be read. The tag's antenna receives electromagnetic energy from an RFID reader's antenna. Using power from its internal battery or power harvested from the reader's electromagnetic field, the tag sends radio waves back to the reader. The reader picks up the tag's radio waves and interprets the frequencies as meaningful data.

Active and semi-passive RFID tags use internal batteries to power their circuits. An active tag also uses its battery to broadcast radio waves to a reader, whereas a semi-passive tag relies on the reader to supply its power for broadcasting. Because these tags contain more hardware than passive RFID tags, they are more expensive. Active and semi-passive tags are reserved for costly items that are read over greater distances—they can in many cases be read 100 feet (30.5 meters) or more away. If it is necessary to read the tags from even farther away, additional batteries can boost a tag's range to over 300 feet (100 meters).

Like other wireless devices, RFID tags broadcast over a portion of the electromagnetic spectrum. The exact frequency is variable and can be chosen to avoid interference with other electronics or among RFID tags and readers in the form of tag interference or reader interference. RFID systems can use a cellular system called Time Division Multiple Access (TDMA) to make sure the wireless communication is handled properly.

Passive RFID tags rely entirely on the reader as their power source. These tags are read up to 20 feet (six meters) away, and they have lower production costs, meaning that they can be applied to less expensive merchandise. These tags are manufactured to be disposable, along with the disposable consumer goods on which they are placed. Whereas a railway car would have an active RFID tag, a bottle of shampoo would have a passive tag.

### SUMMARY

Example embodiments of the present disclosure provide systems of distributed tag tracking. Briefly described, in architecture, one example embodiment of the system, among others, can be implemented as follows: a server configured to receive data from a plurality of wireless devices, the data acquired by the plurality of wireless devices acquired from a common module, the data acquired from the module by the plurality of wireless devices over a short range communication link.

Embodiments of the present disclosure can also be viewed as providing methods for distributed tag tracking. In this regard, one embodiment of such a method, among others, can be broadly summarized by the following steps: pull data from a common module over a short range communication link; and push the data to a server configured to receive data from a plurality of wireless devices.

### BRIEF DESCRIPTION OF THE DRAWINGS

FIG. 1 is a system block diagram of an example embodiment of distributed tag tracking.

FIG. 2 is a system block diagram of an example embodiment of the distributed tag tracking system of FIG. 1.

FIG. 3 is a flow diagram of an example embodiment of a method of distributed tag tracking.

FIG. 4 is a flow diagram of an example embodiment of a method of distributed tag tracking.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

RF tags may be used to acquire data, for example, the location of the tag. If the tag is attached to a particular article, information regarding that article may be acquired. In an example embodiment, items are fitted with RF tags. A mobile phone or other wireless device can track when the tags are in RF range. When this happens, the wireless device may record the time and position (using GPS, cellular triangulation, visible WiFi spots or other locationing methods as non-limiting embodiments). Even using the last previous position (when inside and/or without GPS coverage), will work. When the user wants to know where the item is, he consults the information on the phone. The novel extension adds a server to the system, so that all phones running the system may report any compatible tags that are found, even ones that have no ownership connection. In an example embodiment, at least one wireless device receiving data from a tag/module is not owned by the owner of the tag/module. “Foreign” tag information is submitted to the server and can be turned over to the owner of the tags. In this implementation, the reach of the system may be increased compared to the previous, local implementation. In an example embodiment, information may be anonymized in the server to deal with privacy concerns. Additionally, a plurality of wireless devices are owned by a plurality of owners, at least one owner may be unassociated with another owner of the plurality of owners, and at least one wireless device may report the data to the server without knowledge of transmissions by another wireless device in the plurality of wireless devices.

Positioning systems may use a GPS device in the tag. By distributing the positioning system to mobile phones, the tag itself can be made very low cost and low power. Distributed systems leads to smaller tags, which may be very low cost and may utilize existing connectivity that exists in phones (GPS, Bluetooth, Bluetooth low energy). Sharing information through a server service means that the service may have global reach rather than just local. In an example embodiment, the server controls the parameters for detecting tags and pushing tag information to the server for each wireless device. The server may consider the density of participating wireless devices and/or tags at the current location of the wireless device when adjusting the parameters for detecting tags and pushing tag information for that particular wireless device.

In an example implementation, the Bluetooth 4.0 standard, a low power technology, may be used for the disclosed systems and methods of distributed tag tracking. Data may be sent to the server, extending beyond the static model because the tag may communicate with more than just one phone. In an example embodiment, the tag may communicate with any phone. The software in the phones may receive the identification number from the tag and forward that to the central server. If the phone has knowledge of its own location, for example by access to GPS coordinates, then that information may be forwarded along with the tag ID. The server may then collect data from every tag in range of any participating phone and send it back to the original owner of each particular tag. So as long as a participating cell phone or other wireless device is in range, the location of the tag may be determined. Since any wireless device may be used, the average transmission distance may be lower and the cost of the tag may be reduced.

For example, if a piece of luggage is lost, as long as it is in range of a participating wireless device, the piece of luggage can be located. A point of contention to consider is privacy concerns. If privacy issues are not taken into account, the information may be used for malicious purposes, for spamming, etc. The issue is introduced because the wireless equipment of an unrelated user may be used to track a particular tag. In an example embodiment, an opt-in or opt-out option may be provided to a user. Additionally, cryptography may be used to encrypt the data. In another example embodiment, that the identification number changes over time such that the ability to determine the tag identity is practically a small probability. In this implementation, only the server and user may have access to key information required to map the identification numbers to actual physical tags.

In an example embodiment, the server may be trusted, providing the security functionality. In an example embodiment, some PET tags may be indicated as public while other tags may be private. In this way a trusted group may be designated, so that the information is only available to a trusted group. In an example embodiment, an access system may be implemented on the server to limit access to the tag owner, or other designated users if desired.

In an example embodiment, a user or owner of a wireless device may choose to opt-out so that the wireless device of the user is not used in the system. However, the system may limit that user such that the user has access to use and benefits of the system commensurate with the access that he allows the system to the wireless device of the user. Example embodiments may include one or more options, including a local mode in which the wireless device only detects its own associated tags, and a broad mode in which the wireless device is configured to detect all tags in the area. The participation of a particular wireless device in the system may also be controlled dynamically based on the current resource levels of the wireless devoice, such as battery level or available communication bandwidth.

Although mobile phones may be used to form the system, other wireless devices may be used as well. Example non-limiting devices include a device that has short-range communications capability and that connects to the Internet, such as a Nintendo DS system. Other smart devices such as light fixtures, toaster ovens, etc. that are connected to the Internet could also have these short distance communications capabilities and participate in the system by recognizing tags that pass by them. Information such as temperature and direction among others may be passed in the system. In an example embodiment, the system may have an ID, GPS location, and status.

Control of the transmission of data from the module/tag may be done in several ways and for several reasons. In an example embodiment, the user/owner may restrict the phone's use for tag tracking for, as non-limiting examples, privacy concerns, cost reasons (if not on an unlimited usage scheme, or abroad), philosophical reasons, or health reasons, such as wireless radiation.

In an example embodiment, the capacity of the server may be limited. This limit may be controlled by the wireless device, and may include input from the server. For example, the received signal strength (RSSI) or link quality indication (LQI) of the radio signal from the module/tag to the wireless device may be used for a coarse estimate of the distance (and also direction if there are multiple antennas) to the module/tag from the wireless device. This information may be forwarded to the server, together with information about the location of the wireless device. The server may then combine this information from multiple wireless devices to compute a more accurate position estimate for the module/tag. The estimated distance to the module/tag may also be used by the wireless device to limit the information to the closest modules/tags. The larger the distance to the module/tag, the more likely it is that the same information is forwarded by other participating wireless devices that may be closer. These closer wireless devices may then also offer a better estimate of the module/tag position. For example, the wireless device may allocate a maximum amount of communication bandwidth (bytes/second) for reporting module/tag information. If the wireless device receives information from 100 modules/tags within communication range, and the wireless device only has capacity to transmit information for 10 modules/tags, the wireless device may only report the 10 closest ones. If the wireless device has enough free memory, it could save the information about the rest of the tags until later, and transmit information about more tags when communication capacity is available, but, perhaps, at a lower priority than reporting “newly seen” modules/tags.

In an example embodiment, module/tags may be categorized into several groups that are treated differently based on module/tag IDs and/or static or dynamic information received from the module/tag. Treatment of each group may depend on the choices of the owner/user of the wireless device. As an example, the user/owner may choose to participate in a game or marketing campaign or to subscribe to a certain service.

In example embodiments, modules/tags may have limited energy available—for instance, a small coin cell battery may need to last for years. The module/tags will often have a very low communication duty cycle, such that they will be asleep, for example, 99.99% of the time, and only wake up occasionally to transmit a burst of data. The wireless devices may also save energy by not continuously listening for modules/tags. Therefore, even with a large number of participating wireless devices, the probability of one being within range and listening may be low for any given module/tag transmission. It may, therefore, take hours or days between each time a particular module/tag is detected by the system. The average time between detections may be inversely proportional to the density of participating wireless devices within communication range of the module/tag.

In an example embodiment, the server/system has knowledge about the density of participating wireless devices at the current location of a particular wireless device. The server/system may use that information to instruct a participating wireless device on how often it needs to poll for detection of modules/tags. The server/system may also have knowledge of the IDs of modules/tags that, for example, are reported lost/stolen, and may also have knowledge of the last known position of these modules/tags.

In an example implementation, when 50,000 people are present at a sports venue, the density of both modules/tags and participating wireless devices may be very high. The server/system may then instruct a participating wireless device in that area to reduce the estimated distance it is reporting modules/tags for, and also to reduce the percentage of the time it listens for modules/tags. In an instance in which the density of participation wireless devices is very low, such as in a remote mountain area, the server/system may then instruct participating wireless devices in that area to report all modules/tags within communication range, and also to listen for tags all the time (or the maximum percentage allowed by the owner/user or with the current battery level).

In an example embodiment, the server/system has a list of IDs of modules/tags that are reported lost or stolen, and also has information corresponding to the location when the modules/tags were last detected. The server/system may then send a list to a participating wireless device, containing IDs of modules/tags that it needs to report information about if detected. The list of IDs to send could contain only the modules/tags that are likely to be in the same area as the wireless device (no need to look for things lost on another continent, for example).

In an example embodiment, data associated with each module/tag ID, or other information received from the module/tag, may be used to categorize them into different groups. For example, the owner/user of a particular wireless device has joined a “treasure hunt” or some kind of game. The server/system may then send a dedicated list of module/tag IDs, or other information required to identify the associated modules/tags for the “treasure hunt” or game, to that particular wireless device.

In an example embodiment, a module/tag transmits particular information based on its status, sensor inputs or user interactions (buttons etc). Each wireless device then knows, or may be instructed by the server/system, about certain aspects of the information received from module/tags with a certain ID category that will trigger the wireless device to send information for the module/tag to the server/system. For example, a water sensor placed in a basement may detect water leakages. In this case, the participating wireless device will only report information from a module/tag of this category when that module/tag has actually detected a water leakage. The different control mechanisms in these examples certainly be combined or applied simultaneously.

In an example embodiment, the communication is a one-way communication. In an alternative embodiment, the communication may be two-way. So information on the tag may be reset or information may be sent to the tag. For example, a tag with a display may be sent a message from the server to be output on the display. In an example implementation using a transceiver tag/module, the tag/module may retrieve location information from the wireless device and update and/or save the location information on the tag/module. The tag/module may report its latest known location if requested.

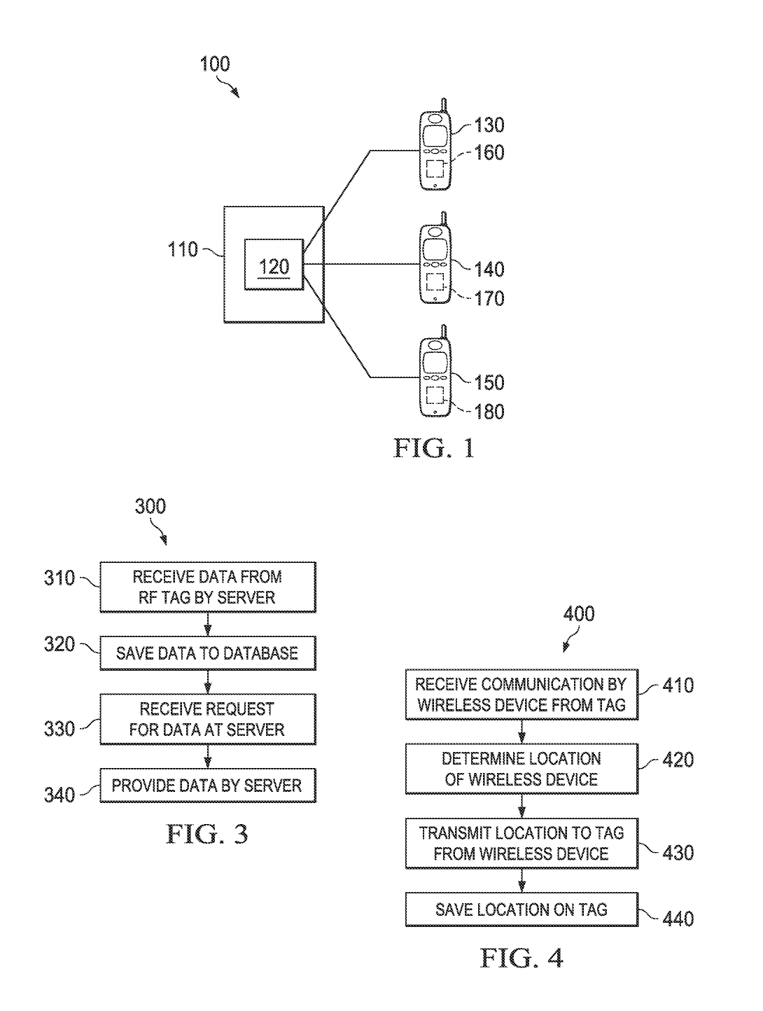

FIG. 1 provides system block diagram 100 of an example embodiment of a system of distributed tag tracking. System 100 includes item 110 with tag 120. Wireless devices 130, 140, and 150 comprise receivers 160, 170, and 180 respectively for receiving information from RF ID tag 120. In a typical system, a single wireless device is configured to receive data from tag 120. However, in the disclosed system of distributed tag tracking, multiple receivers 160, 170, and 180 may be configured to receive information form tag 120 as well as from other tags. This information may, combined with other data known to the wireless device, such as location and the current time, then be sent to a central server for processing the information from the tag.

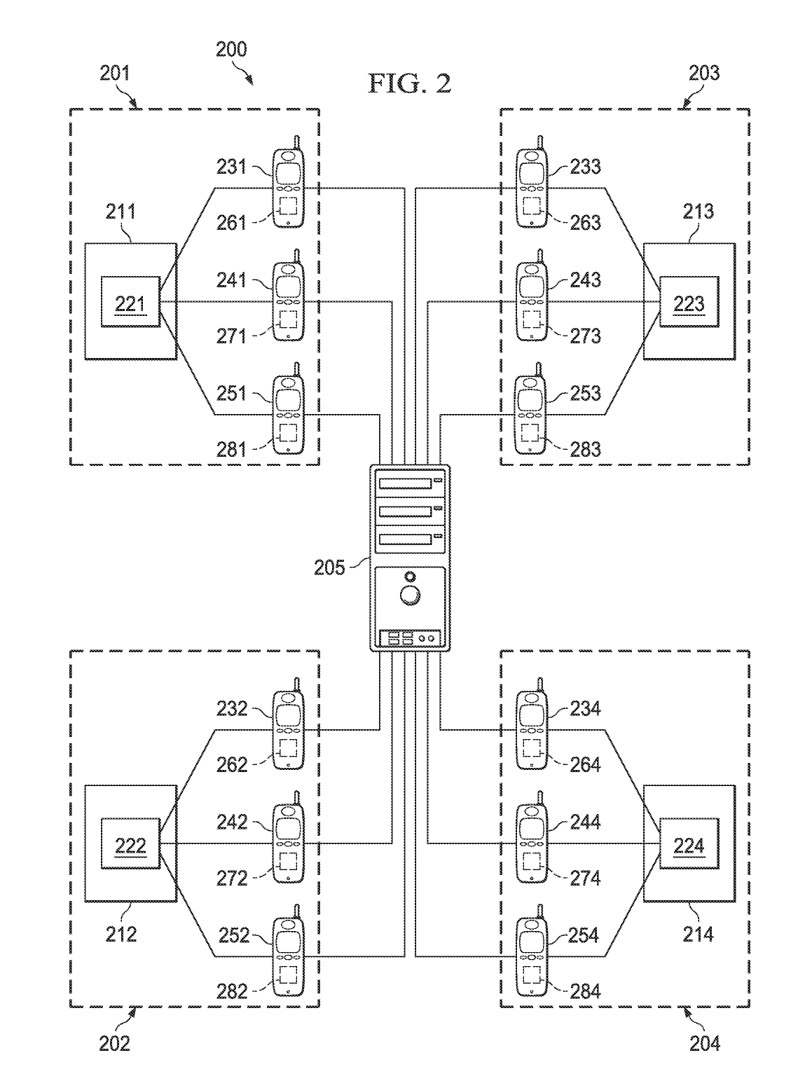

FIG. 2 provides system block diagram 200 of a system of distributed tag tracking. System 200 includes system 201 with item 211 and associated tag 221. In an example embodiment, tag 221 is an RFID tag. Information from RFID tag 221 is received by one or more of wireless devices 231, 241, and 251, with respective receivers 261, 271, and 281. The information from each of wireless devices 231, 241, and 251 is sent to central server 205 where it is collected and processed. System 200 may also include system 202 with item 212 and associated tag 222. In an example embodiment, tag 222 is an RFID tag. Information from RFID tag 222 is received by one or more of wireless devices 232, 242, and 252, with respective receivers 262, 272, and 282. The information from each of wireless devices 232, 242, and 252 is sent to central server 205 where it is collected and processed.

Likewise, system 200 may also include system 203 with item 213 and associated tag 223. In an example embodiment, tag 223 is an RFID tag. Information from RFID tag 223 is received by one or more of wireless devices 233, 243, and 253, with respective receivers 263, 273, and 283. The information from each of wireless devices 233, 243, and 253 is sent to central server 205 where it is collected and processed. Moreover, system 200 may also include system 204 with item 214 and associated tag 224. In an example embodiment, tag 224 is an RFID tag. Information from RFID tag 224 is received by one or more of wireless devices 234, 244, and 254, with respective receivers 264, 274, and 2842. The information from each of wireless devices 234, 244, and 254 is sent to central server 205 where it is collected and processed.

Information from any of tags 221, 222, 223, and 224, may be received by an appropriately configured wireless device. The wireless device may then pass the information received from the tag to a server for collection. The server may collect information from a plurality of tags. Server 205 may compile information from tags 221, 222, 223, and 224 for various purposes. Four tags are shown in FIG. 2, but this is for illustration purposes only. Any number of tags may be used in the system.

In an alternative embodiment, data from the wireless devices may be pushed to tags 221, 222, 223, 224. In this implementation, the tags have receiver capabilities. For instance, a wireless device may determine it's location through a GPS service, and send the GPS information to the tag. Since the communication link Is a short range communication link, the location of the wireless device is a good approximation for the location of the tag.

FIG. 3 provides flow chart 300 of an example embodiment of a method of distributed tag tracking. In block 310, data from an RF tag is received by a server. In block 320, the data is saved to a database, preferably on the server. However, the database may be located elsewhere. In block 330, a request for the data is received by the server. In block 340, the data is provided by the server.

FIG. 4 provides flow chart 400 of an example embodiment of a method of distributed tag tracking. In block 410, a communication from the tag is received by a wireless device. A communication application is loaded on the wireless device. The application receives the communication from the tag and may establish a communication channel. In block 420 the wireless device determines its location. In an example embodiment, the communication channel is a short range communication, so the location of the wireless device is a fair approximation of the location of the tag. In block 430, the location information is transmitted to the tag from the wireless device. In block 440, the location information is saved on the tag. In an example embodiment, the location information is saved in non-volatile memory.

The flow charts of FIG. 3 and FIG. 4 show the architecture, functionality, and operation of possible implementations of distributed tag tracking software. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 3 or FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiments, including the server can be implemented in hardware, software, firmware, or a combination thereof. In example embodiments, the logic is implemented in software or firmware that is stored in a memory and that is executed by a suitable instruction execution system. The server includes one or more processing units that are operable to execute computer software instructions and to manipulate data according to the computer software instructions. A processor unit can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums. The server further includes, or is communicatively connected to, volatile and non-volatile memory for storing computer software instructions to be executed by the processing unit(s) and for storing and recalling data related to the tags/modules.

Additionally, the server comprises an operating system that controls and manages operation of the server and that includes computer software instructions executed by the server's processing unit(s). The server further comprises a plurality of computer software and data components that cooperatively cause the server to provide distributed tag tracking functions. The operating system and computer software and data components, according to example embodiments are stored on or by the server's volatile and/or non-volatile memory. In other embodiments, the computer software and data components, or portions thereof, may be stored on or by device(s) that are not part of the server. The computer software and data components include a distributed tag tracking software component having a plurality of computer software instructions that when executed by a processing unit(s) of the server, causes the server to perform according to a distributed tag tracking method described hereinabove.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A system comprising:
a server configured to receive data from a plurality of wireless devices, the data acquired by the plurality of wireless devices acquired from a common module, the data acquired from the module by the plurality of wireless devices over a short range communication link.

2. The system of claim 1, wherein the short range communication link comprises Bluetooth.

3. The system of claim 1, wherein the module comprises an RF ID tag.

4. The system of claim 1, wherein acquisition of the data by the server is controlled by the wireless device.

5. The system of claim 4, wherein the wireless device is configured to control the parameters for detecting modules and pushing data to the server for the wireless device.

6. The system of claim 4, wherein the wireless device is configured to adjust resources for detecting and reporting module data.

7. The system of claim 1, wherein the short range communication link comprises a one way link.

8. The system of claim 7, wherein the short range communication link comprises a two way link.

9. The system of claim 8, wherein the server is further configured to push data to the module through a mobile phone over the two way short range communication link.

10. The system of claim 1, wherein the server parses information related to tags by pre-selected criteria.

11. The system of claim 10, wherein the pre-selected criteria comprises at least one of ownership, location, and status.

12. A computer readable medium on a mobile device comprising a software program, the software program comprising a set of instructions for:
pulling data from a common module over a short range communication link; and
pushing the data to a server configured to receive data from a plurality of wireless devices.

13. The computer readable medium of claim 12, wherein the data comprises the location of the module.

14. The computer readable medium of claim 12, wherein the short range communication link uses the Bluetooth protocol.

15. The computer readable medium of claim 12, further comprising instructions for configuring parameters for detecting modules and pushing data to the server for the wireless device.

16. The computer readable medium of claim 12, further comprising instructions for configuring resources for detecting and reporting module data.

17. A mobile device comprising:
a processor configured to:
pull data from a common module over a short range communication link; and
push the data to a server configured to receive data from a plurality of wireless devices.

18. The mobile device of claim 16, wherein the data comprises a location of the module.

19. The mobile device of claim 16, wherein the short range communication link uses the Bluetooth protocol.

20. The mobile device of claim 16, wherein the processor is further configured to control the parameters for detecting modules and pushing data to the server for the wireless device.

21. The mobile device of claim 16, wherein the processor is further configured to adjust resources for detecting and reporting module data.
